(19) United States
(12) Patent Application Publication
(10) Pub. No.: US 2010/0310967 A1
(43) Pub. Date: Dec. 9, 2010

(54) BATTERY DEVICE AND METHOD OF PACKAGING, DISASSEMBLING, AND RECYCLING THEREOF

(75) Inventors: Hsueh Cheng Huang, Taipei (TW); Keng-Rong Chang, Taichung (TW); Guo-Lin Lee, Changhua (TW); Wan Ching Chiu, Hong Kong (CN); Fu-Sheng Li, Taichung (TW)

Correspondence Address: Mr. Peter F. Corless;Mr. Steven M. Jensen, Edwards Angell Palmer & Dodge LLP, 111 Huntington Avenue,, Boston, MA, 02199-7613, US

(73) Assignee: Advanced Power and Energy Sources (HK) Company Limited, Hong Kong (HK)

(21) Appl. No.: 12/560,880

(22) Filed: Sep. 16, 2009

(30) Foreign Application Priority Data
Jun. 3, 2009 (TW) 098118318

(51) Int. Cl. H01M 2/02; H01M 8/04; H01M 10/42

(52) U.S. Cl. 429/507; 29/623.1; 429/535

(57) ABSTRACT

The invention provides a battery device and a method for packaging, disassembling, and recycling the battery device, wherein the anode conductive element is disposed in a reaction trough frame with a bump thereof protruding from the frame; two sets of the cathode conductive elements cover on a first opening and a second opening of the reaction trough frame, respectively, so as to form a reaction region for accommodating electrolyte therein; and a metallic fastener is disposed on surfaces of the cathode conductive elements and the reaction trough frame and fastened with a buckling member. The invention provides a simple structure that can be packaged rapidly, disassembled and recycled to thereby overcome the drawbacks of conventional batteries.

### BACKGROUND OF THE INVENTION

1. Field of the Invention

The present invention relates to a battery device and a method of packaging, disassembling and recycling the battery device, and, more specifically, to a battery device capable of being rapidly packaged, disassembled and recycled.

2. Description of Related Art

With regard to power sources, despite the emergence of solar, wind, tidal and geothermal alternatives, modern society still relies on stable power sources like fossil fuels (coal, oil and gas) or nuclear power. However, fossil fuels and nuclear power have serious environmental problems and low energy-conversion efficiency, making alternative energy increasingly attractive. But the great bottleneck for alternative sources is their general inability to provide stable power generation. Hence the fuel cell, which converts chemical energy into electricity, has been proposed as a solution that would provide both good stability and efficiency.

A fuel cell is a kind of power supply, like a small power station, that can directly convert chemical energy into electricity. The minimum elements to compose a fuel cell include a cell body, two electrodes, electrolyte, electrolyte membrane, and/or current collector. Simply speaking, the operational theory behind the fuel cell can be taken as the reverse reaction of the electrolysis of water. The electrodes are the place where electrochemical reaction occurs, like the oxidation of fuel and reduction of oxidant, or they can be the diffusing media for anode chemical fuel. Such electrodes can be generally categorized into anodes and cathodes. The function of electrolyte is to isolate the oxidant and the reductant, and it also conveys protons at the same time. Furthermore, the current collector, also called a “bipolar plate,” has functions like collecting current, dissipating reaction gas, and isolating oxidant and reductant.

Generally speaking, the most common fuel cells include hydrogen-oxygen fuel cells which use hydrogen and oxygen as fuel, and metal-oxygen fuel cells which use metal and oxygen as fuel. As for the hydrogen-oxygen fuel cell type, hydrogen is first introduced and decomposed into a hydrogen proton and electron by the catalyst. Then, the hydrogen proton passes through the electrolyte, reacts with the oxygen from the cathode, and combines with the electrons in the circuit to generate water and heat. As a consequence of these reactions, electrical current is generated from the movement of electrons. As for the metal-oxygen fuel cell, the metal reacts with the diffusing oxygen introduced by the air electrode, and such oxidation will simultaneously generate electricity and other resultants like metal oxides, hydrogen and/or water. Thus, nowadays fuel cells have the advantages of low pollution, high efficiency, no noise, and so on, and they can reuse the subsequently recycled resultants. Moreover, this kind of fuel cell can receive oxygen from the surrounding air to use in the reaction.

With technological advances, a number of choices exist for the fuel used by a fuel cell. For example, such a fuel may include pure hydrogen, methanol, alcohol, natural gas, metal, or—the most generally used—gasoline. In addition, a hybrid power system composed of a fuel cell and a fuel tank may supply power for transportation, namely applied to vehicles, aircraft, and ships. For this reason, hybrid power mechanisms have become the trend of future designs of many manufacturers.

On another matter, as a design consideration, disposability is being increasingly adopted for the packaging technology of existing primary and secondary batteries. Primary batteries are designed to be used only once, and secondary batteries can only be recharged a finite number of times before needing to be replaced. In the past, both types were often discarded, although, nowadays, their materials are being increasingly recycled for multiple environmental reasons and perhaps for cost-savings. However, it is not feasible to rapidly disassemble such a battery and to recycle its internal materials at the end of its life with the conventional designs. Complicating recycling, manufacturers typically connect multiple batteries or fuel cells in serial or parallel in order to achieve the stable and required voltage or current level. And the packaging mechanism of a fuel cell is getting more complex to provide better packaging, particularly for safety. This not only increases the size of a fuel cell but also complicates the structure so that it is more difficult to disassemble or recycle such a fuel cell. The situation gets worse when multiple cells are connected in series or parallel together with a fuel tank to form a hybrid power mechanism. Moreover, when a fuel cell runs out of fuel, it is typically necessary to send the cell back to the manufacturer or to a maintenance company for recycling, and the cell will need to undergo a series of complex processes in order to be disassembled and repackaged. This further increases the costs in terms of labor and equipment.

As a result, it is beneficial to provide a battery device that can be rapidly and conveniently packaged, disassembled, and recycled. Such a battery device would overcome the drawbacks of prior art related to a complicated structure and difficulty of packaging and recycling.

### SUMMARY OF THE INVENTION

In order to overcome the drawbacks of the prior art, the present invention provides a battery device comprising: a reaction trough frame, an anode conductive element, at least two sets of cathode conductive elements, and a metallic fastener.

The reaction trough frame has a firs opening and a second opening, and there is at least a hole on its side. The anode conductive element is disposed inside the reaction trough frame and it is not exposed through the first and second openings. The anode conductive element has at least one anode conductive bump protruding from the reaction trough frame through the side hole. The cathode conductive elements fully cover the first and second openings of the reaction trough frame so as to form the reaction region inside the r action trough frame for accommodating electrolyte therein. The metallic fastener is disposed on the surfaces of the cathode conductive element and the reaction trough frame so as to be electrically coupled to the cathode conductive element. The metallic fastener further comprises at least one opening portion, and the opening portion exposes a portion of the surface of the cathode conductive element, as well as a portion of the surface of the reaction trough frame. In addition, the metallic fastener has at least one cathode conductive bump. The battery device provides electricity by the anode conductive bump and/or the cathode conductive bump.

According to a preferred embodiment of the present invention, the battery device further includes at least one budding member configured to buckle and fasten the metallic fastener.

The invention further provides a method of packaging said battery device. The method includes the following steps: (1) disposing the anode conductive element inside the reaction trough frame, and the anode conductive bump protruding from the reaction trough frame through the side hole; (2) fully covering the first opening and second opening of the reaction trough frame, respectively, by the cathode conductive elements, thereby forming a reaction region, and filling electrolyte into the reaction region; and (3) disposing the metallic fastener on surfaces of the cathode conductive element and the reaction trough frame, and electrically coupling the cathode conductive element and the metallic fastener.

Furthermore, in order to improve the stability of the whole battery device structure, the battery device packaging step further includes (4) using at least one buckling member to buckle and fasten the metallic fastener.

The invention further provides a method of disassembling and recycling said battery device. The method includes the steps of: (1) separating the metallic fastener, the cathode conductive element, the anode conductive element and the reaction trough frame from the battery device; (2) cleaning the metallic fastener, the reaction trough frame, the cathode conductive element and/or the anode conductive element in order to remove resultants generated during the reaction of the battery device; and (3) recycling the cleaned metallic fastener, the cathode conductive element, the anode conductive element and/or the reaction trough frame and proceeding to a subsequent reutilization process.

When compared with the prior art, the said battery device and method of disassembling and recycling the same provide a simple architecture and an easier way to package and disassemble, thereby overcoming the drawbacks of the complicated battery architecture in the prior art. The invention further provides a user a more convenient, rapid, and cost-effective way to package, disassemble and/or recycle the battery device so as to save time and costs.

### BRIEF DESCRIPTION OF VIEWS

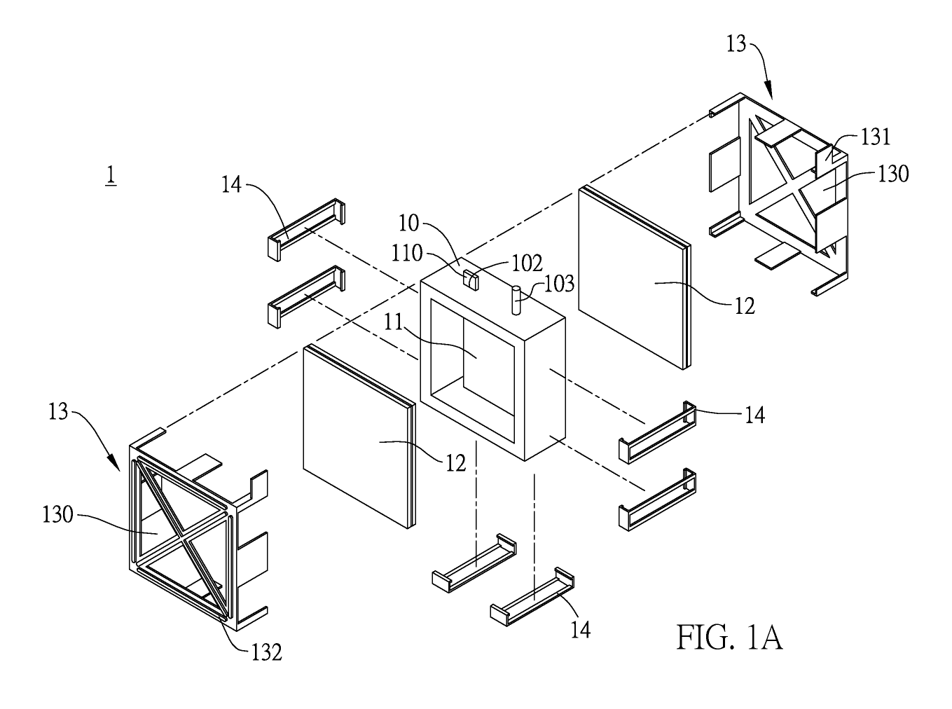

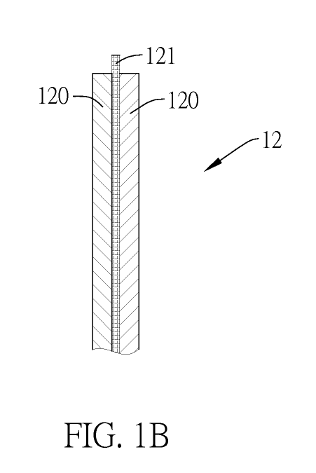

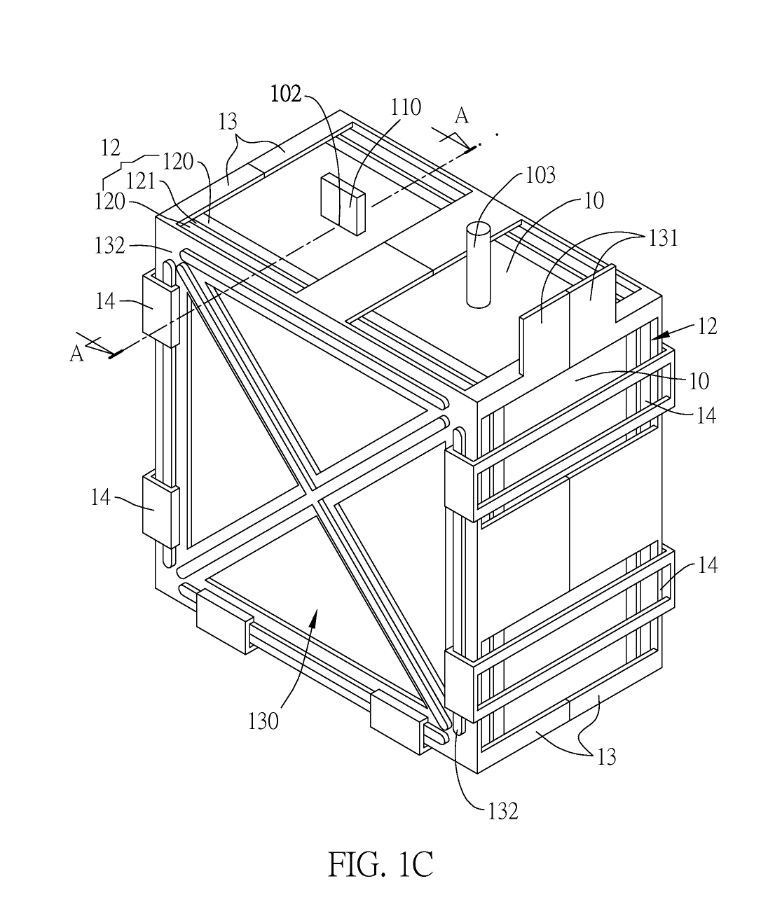

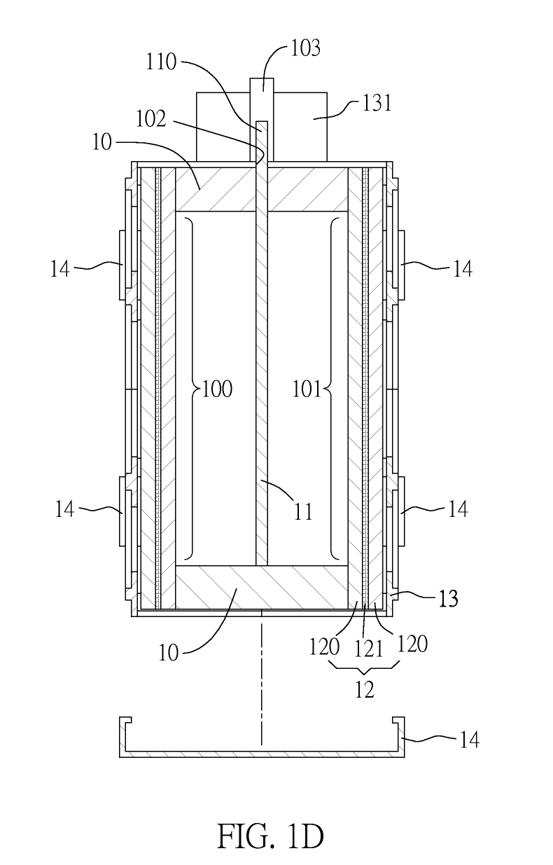

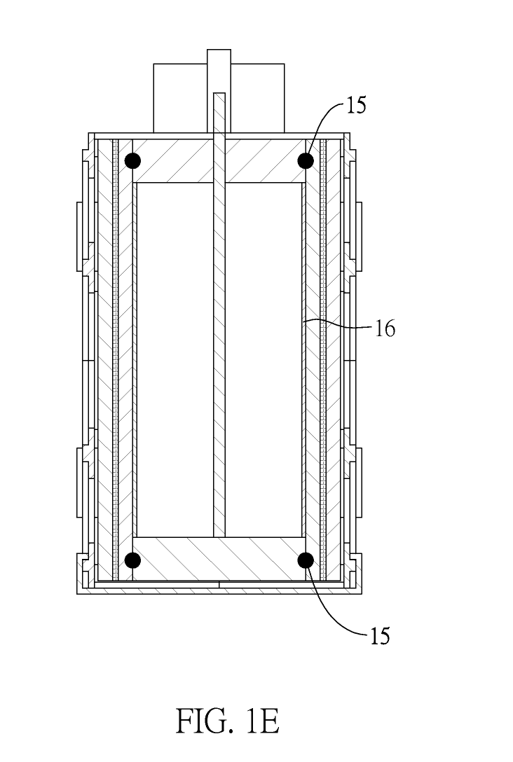

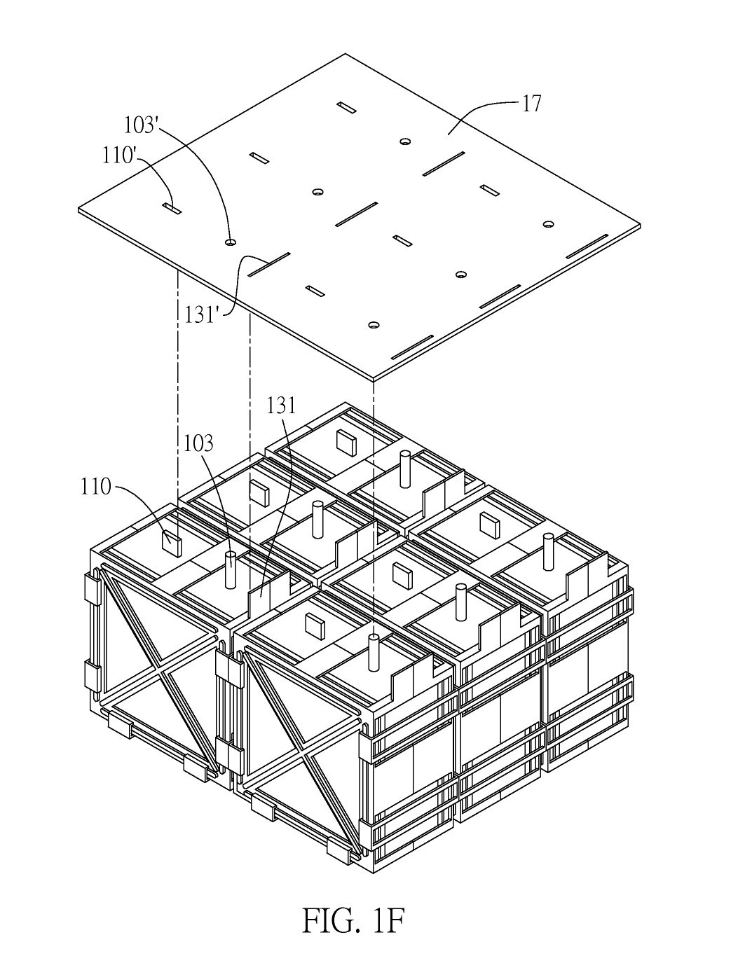

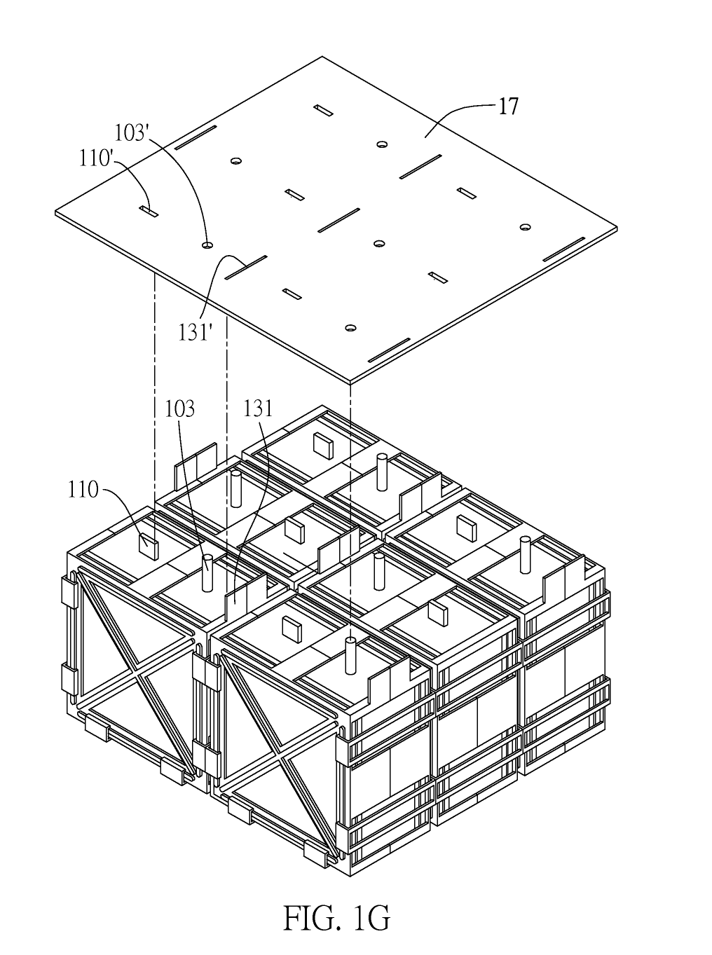

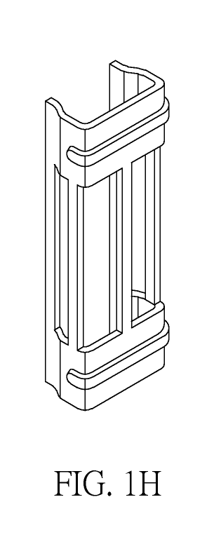

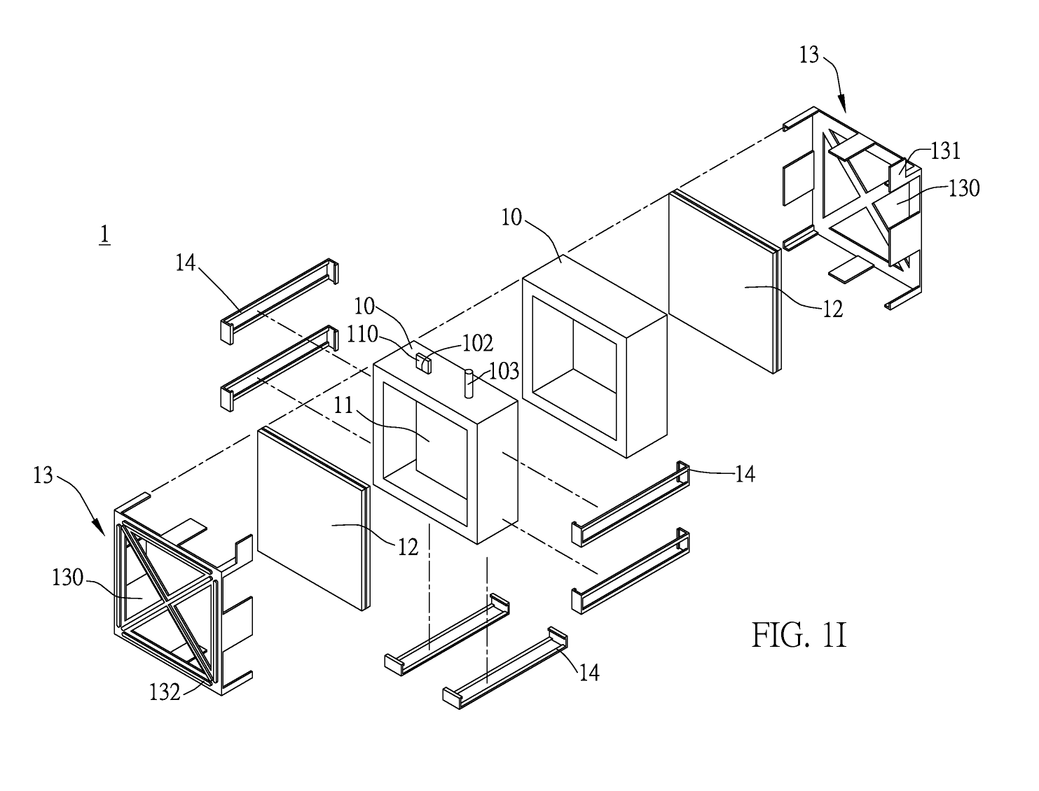

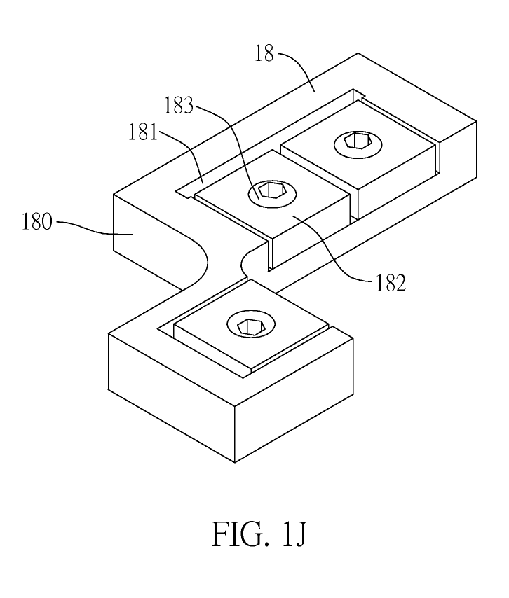

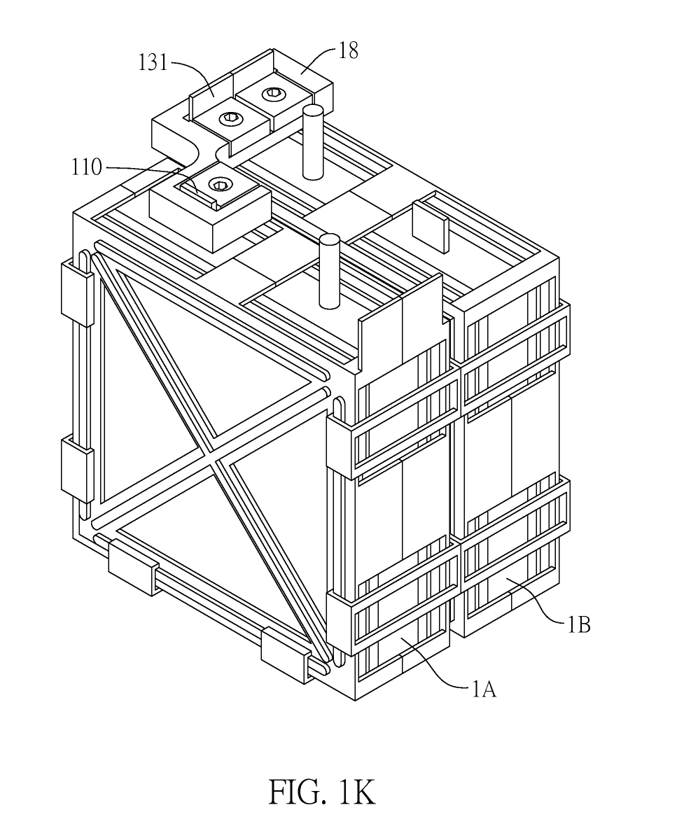

FIG. 1A is an exploded view view of the battery device according to the present invention;

FIG. 1B is a cross-sectional view of the cathode conductive element of the battery device according to the present invention;

FIG. 1C is a perspective view view of the battery device according to an embodiment of the present invention;

FIG. 1D is a cross-sectional view of the battery device according to an embodiment of the present invention;

FIG. 1E is a cross-section view of the battery device according to another embodiment of the present invention;

FIG. 1F is a partially exploded perspective view view of the battery device with the top plate element raised to expose the area below according to an embodiment of the present invention;

FIG. 1G is a partially exploded perspective view view of the battery device with the top plate element raised to expose the area below according to another embodiment of the present invention;

FIG. 1H is a perspective view view of the buckling member of the battery device according to the present invention;

FIG. 1I is an exploded view view of the battery device according to another embodiment of the present invention;

FIG. 1J is a perspective view of the connector of the battery device according to the present invention;

FIG. 1K is an partially exploded perspective view of series connection of the battery devices with the connector according to the present invention;

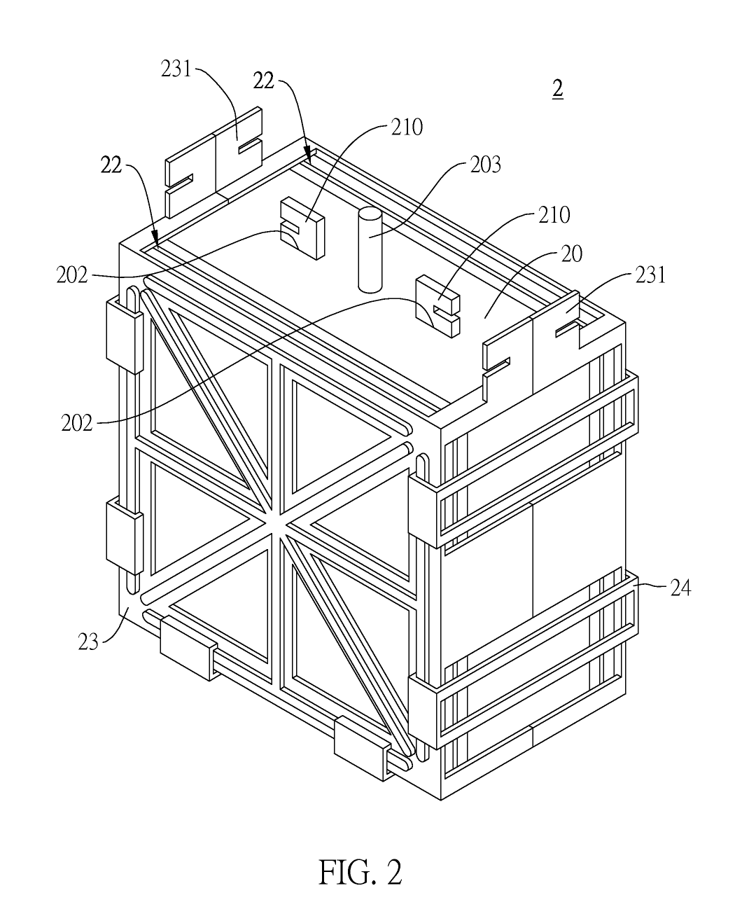

FIG. 2 is a perspective view view of the battery device according to yet another embodiment of the present invention;

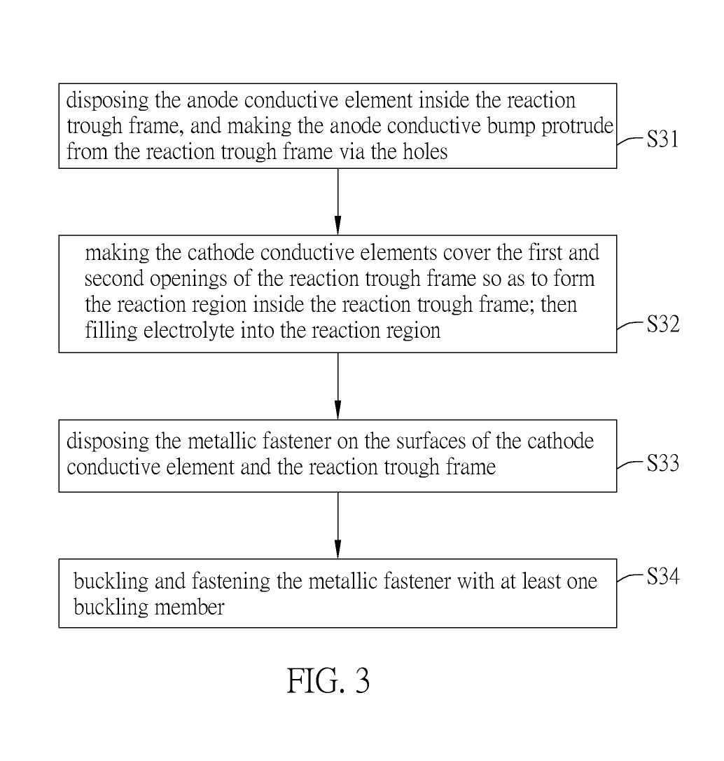

FIG. 3 is a flow chart illustrating the packaging steps of the battery device, according to the present invention; and

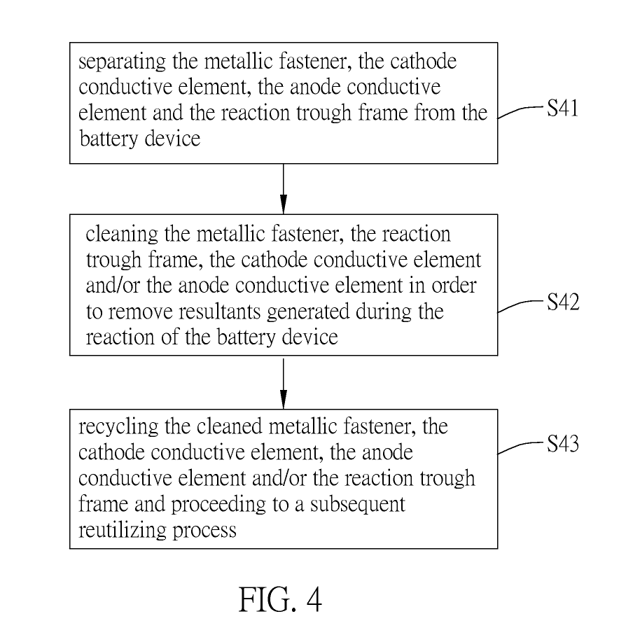

FIG. 4 is a flow chart illustrating the disassembling and recycling steps of the battery device, according to the present invention.

### DETAILED DESCRIPTION OF PREFERRED EMBODIMENTS

Specific embodiments are herein described in detail to explain the present invention, wherein numerous advantages and effects will be readily apparent to those skilled in the art once the disclosure is fully appreciated. It should be noted that the present invention may be implemented with various embodiments. According to different aspects and applications, the details of this specification may be altered or modified without departing from the spirit of the present invention.

FIG. 1A provides an exploded view of the battery device according to the present invention. As shown in FIG. 1A, the battery device 1 includes: a reaction trough frame 10, an anode conductive element 11, two sets of cathode conductive elements 12, a metallic fastener 13, and buckling member 14.

The reaction trough frame 10 is made of plastic, artificial or natural rubber, ethylene propylene diene methylene (EPDM), and so on. It has a first opening 100 (see FIG. 1D), second opening 101 (see FIG. 1D), hole 102 on a side of reaction trough frame 10, and inlet/outlet 103. Since material like plastic, artificial or natural rubber, and EPDM are elastic materials, the reaction trough frame 10 is capable of distributing harmful stress and it is leak-proof. The reaction trough frame 10 may also be customized to have characteristics like resistance to degradation when exposed to acidic or alkaline solutions. Notably, the number of holes 102 to be disposed is also customizable depending on the desired requirements, like the current capacity.

The inlet/outlet 103 is used to draw in the gaseous fuel needed for cell electrolysis. For example, if battery device 1 is a hydrogen fuel cell, inlet 103 draws in hydrogen to assist the electrolysis. The inlet/outlet 103 is also applicable to exhausting gaseous wastes after completion of the battery electrolysis, or to exhausting additional gases. For example, if battery device 1 is a metal-air fuel cell, outlet 103 exhausts hydrogen after completion of the battery electrolysis. The inlet/outlet 103 may further be used as an access for adding related additives, like those used during the startup of the battery device.

Additionally, depending on the requirements, the inlet/outlet can be customized in terms of number, shape, length or aperture. The inlet/outlet may be integrated into the reaction trough frame 10 or disposed separately. In one embodiment, a plurality of holes 102 are first formed on the sides of reaction trough frame 10 by means of physical or chemical etching. Then, inlets/outlets 103 are connected into holes 102. For example, the design of the inlets/outlets 103 and the holes 102 may include a screw thread so that the inlets/outlets 103 can be screwed into holes 102. The inlets/outlets 103 may be made of nylon or plastic so that they are flexible and leak-proof. The design of the outer surface of an inlet/outlet 103 may also include multiple annular layers or screw thread, so that it is easier to be connected with other pipes and it can prevent the backward flow of gases and liquids.

The anode conductive element 11 is disposed inside the reaction trough frame 10. It has at least an anode conductive bump 110 which protrudes from hole 102. In one embodiment, the aperture of hole 102 can be designed to be a little bigger than the size of anode conductive bump 110, so that after anode conductive bump 110 has protruded from hole 102, the hole 102 can securely coupled with anode conductive bump 110 due to the flexibility of reaction trough frame 10.

In another preferred embodiment, anode conductive element 11 is made of Al, Zn, Mg and/or other solid, polymer electrolytic materials. Further, when in view of conventional chemical reactions, anode conductive element 11 is taken as an anode terminal when battery device 1 generates electricity; however, when in view of the direction of the current generated by battery device 1, anode conductive element 11 is taken as a cathode terminal.

The two sets of cathode conductive elements 12 fully cover first opening 100 and second opening 101 of the reaction trough frame, respectively. The cathode conductive element 12 and reaction trough frame 10 jointly form a reaction region for accommodating electrolyte therein. Generally speaking, the electrolytic solution is an aqueous solution comprising Zn—MnO₂, Zn—HgO, or KOH. In a preferred embodiment, the cathode conductive element 12 may be a kind of laminated separation membrane or composite fiber structure having very small holes that only allow gas molecules like oxygen to pass. Thus, it is capable of repelling water so to prevent leakage of the electrolyte and prolongs the battery lifetime. Moreover, when in view of chemical reactions, cathode conductive element 12 is taken as a cathode terminal when battery device 1 generates electricity; however, when in view of the direction of the current generated by battery device 1, cathode conductive element 12 is taken as an anode terminal.

The metallic fastener 13, which is disposed on surfaces of the cathode conductive element 12 and reaction trough frame 10, is applicable to fastening battery device 1 and electrically coupled to the cathode conductive element 12. The metallic fastener 13 may be made of metal enclosed with plastic or metal of good malleability like Al, Fe, Cu or Sn. Prior to assembly, all of these metal materials undergo anti-corrosion treatment. The thickness of metallic fastener 13 may be customized based on the requirements, for example, ranging from 0.1 mm to 5 mm. Furthermore, in order to partially expose the surface of cathode conductive element 12 and the surface of reaction trough frame 10, the metallic fastener 13 is designed to be hollow to form a plurality of open portions 130 to thereby draw in the required gas, such as oxygen, during the chemical reaction through the cathode conductive element 12. In addition, it also accelerates the dissipation of trace water/vapor generated during the chemical reaction, so that the structure is not distorted or weakened by unwanted stress.

Metallic fastener 13 further includes a cathode conductive bump 131. The cathode conductive bump 131 and the anode conductive bump 110 provide electricity to external devices and thereby form a circuit. Note that a projective convex rib 132 may be formed on the surface of metallic fastener 13, thereby strengthening the metallic fastener structure. The convex rib 132 may also be formed in the shape of a rectangle, a triangle, a polygon and so on.

The buckling member 14 is buckled on the metallic fastener 13 to further fasten and strengthen the battery device 1 of the invention. The structure of the buckling member 14 may be a common metallic clamp, or it can be designed, for example, as a hollow structure which forms air-flow pipes in order to achieve better heat dissipation. Hence the whole structure of battery device 1 gets stronger through the pressure provided by the buckling member 14. Such pressure can also be customized according to user requirements. In practice, the buckling member 14 can be covered with one or more insulating layers like fiber-reinforced polypropene (FRPP), ultra high molecular weight polyethylene (UHMW-PE), polyethylene terephthalate (PETP), polyvinyl chloride (PVC), and/or polypropene (PP). These layers not only provide insulation but also prevent electromagnetic interference.

FIG. 1B is a cross-section view of the cathode conductive element 12 of the battery device according to the present invention. The cathode conductive element 12 is a laminated fiber structure composed of a carbon dust layer 120 and a metal net layer 121. The material of the carbon dust layer 12 includes carbon fiber and/or graphite. The materials of the cathode conductive element 12 allow it to provide ventilation while being impervious to water (water proof) because the aperture size of the fiber holes is so small that only gas molecules can pass. Also, the metal net layer 121 may be made of conductive metal having characteristics of anti-corrosiveness, like Ni, Ag, Cu with Ag coating, Fe with Ni coating, and so on. The shape of the metal net layer 121 may be a plate, a net, or structures with holes or foam. In practice, the length of the metal net layer 121 is designed to be longer than that of the carbon dust layer 120. The protruding portion can be folded down on the carbon dust layer 120 and it can be pressed and fastened by the metallic fastener 13, thereby leading to a larger contact area between the metallic fastener 13 and metal net layer 121 so as to achieve better electrical coupling.

FIG. 1C shows a perspective view of the packaged battery device 1, whereas FIG. 1D shows a cross-sectional view cut along line A-A of the battery device 1 in FIG. 1C. The structural characteristics are as the same as those of the above embodiment and will not be mentioned here for simplicity.

FIG. 1E is another cross-section view of the battery device 1 of the invention. When compared with the above embodiment, the main difference is that there is at least a leak-proof member 15 on the contact surface between the reaction trough frame 10 and the cathode conductive element 12. Another difference is that there is at least one layer of insulating element 16 disposed on the surface of cathode conductive element 12.

The material of leak-proof member 15 may include elastic materials like artificial or natural rubber, and its shape may include a sphere, a flat piece, a spacer with a groove, or a spacer of other shapes that is disposed around the edge of the opening of reaction trough frame 10. The leak-proof member 15 is applicable to preventing leakage of electrolyte, distributing harmful stress, and fastening reaction trough frame 10 and cathode conductive element 12 on their relative positions, so that cathode conductive element 12 will not slide and leak the electrolyte. For example, during the reaction of battery device 1, if additional resultants like gases or crystalloids are generated and thereby deform the battery device 1, the leak-proof member 15 can prevent the electrolyte from leaking out.

The insulating element 16 may be an insulating and isolating film or spacer made of carbon dust or graphite in sheet form. It is applicable to preventing the anode conductive element 11 from indirectly contacting the cathode conductive element 12 that would result in a short circuit. For example, during the reaction of the battery device 1, if additional resultants like crystalloids are generated and thereby make the anode conductive element 11 indirectly contact the cathode conductive element 12, the insulating element 16 can prevent the occurrence of a short circuit. Note that if the battery device 1 is designed to be a primary cell, the battery can be packaged without the insulating element 16, or the battery can be directly packaged with the permeable material of the air diffusion layer 130.

Referring to FIG. 1F and 1G, both figures show that on top of a plurality of said battery devices 1 there is disposed a top plate element 17 to form a battery module comprising a plurality of battery devices 1. The top plate element 17 is a flat piece and it can be made of materials like plastic or rubber.

The top plate element 17 at least has an anode opening 110′ associated with anode conductive bump 110, a cathode opening 131′ associated with cathode conductive bump 131, and/or a pipe opening 103′ associated with inlet/outlet 103. In practice, the length, width, and the number of said openings (110′, 131′ and 103′) of the top plate element 17 are all customizable according to user requirements. The required voltage and current is provided by the battery module comprising a plurality of battery devices 1.

In one embodiment, when constructing the battery module as shown in FIGS. 1F and 1G, a belt, box or fastener (e.g. a screw) can also be used for further fastening the top plate element 17. The insulating materials may be further applied on the local surface of each metallic fastener 13, or the insulating materials (e.g. PET sheet) can be inserted into the gaps between batteries, so as to prevent interference between adjacent battery devices 1.

In another embodiment, one or more layers of catalytic conversion materials may be applied on anode conductive element 12 and cathode conductive element 13 (not shown). Such layers may be made of powder of Pt, Ru or C, or the combination thereof. For example, assume that the battery device 1 is a hydrogen fuel cell. First, the hydrogen flows into the reaction region via inlet/outlet 103, and the hydrogen is converted into hydrogen ions and electrons (e.g., H₂=>2H++2e−) by the layers of catalytic conversion. Then, the hydrogen ions and electrons, together with the oxygen that flows in via cathode conductive element 13, are further catalyzed into water by the layers providing catalytic conversion (e.g., 4H++4e−+O₂=>2H₂O).

FIG. 1H shows another perspective view of the buckling member 14 of the battery device 1, according to the present invention. The buckling member 14 may include a plurality of hollow structures with specially designed tilt angles. When the battery devices 1 are constructed like the battery module in FIG. 1F and FIG. 1G, a plurality of such hollow structures provide good ventilation in order to improve the efficiency of heat dissipation for the whole battery module.

FIG. 1I shows an exploded view of another embodiment of the battery device 1 according to the present invention. Inside the battery device 1, a plurality of reaction trough frames 10 with or without anode conductive elements 11 may be serially coupled to form a larger reaction trough frame with a plurality of reactive fuel blocks/sections. Then, the two sets of cathode conductive elements 12, metallic fasteners 13, and buckling members 14 are applied to thereby form a larger battery device. Note that the length, thickness and strength of the metallic fastener 13 and buckling member 14 can all be adjusted depending on the number of reaction trough frames 10 connected in series.

Referring to FIG. 1J, there is shown a perspective view of the connector of the battery device according to the present invention. As shown in the drawing, the connector 18, which may be a plastic or fibrous based electrical conductive metal fastener, comprises a base 180 and a metal block 182. The base 180 has at least a penetrating opening 181 for holding the cathode conductive bump of the first battery device and the anode conductive bump of the second battery device, and vice versa (that is, an anode conductive bump of a first battery device and a cathode conductive bump of a second battery device), to thereby enable the cathode conductive bump of the first battery device to come into indirect contact with the anode conductive bump of the second battery device, and vice versa. The metal block 182 has a eccentric screw 183 therein. The eccentric screw 183 is configured to be rotated to thereby push the metal block 182 until the cathode conductive bump and the anode conductive bump are fixed in position. As shown in the drawing, the eccentric screw 183 is rotated until the relatively thick portion thereof faces the penetrating opening 181; meanwhile, the eccentric screw 183 pushes the metal block 182 to move toward the penetrating opening 181. Hence, owing to the base 180 and the metal block 182, the cathode conductive bump and the anode conductive bump are fixed in position to the penetrating opening 181 and allowed to come into indirect contact with each other, respectively.

FIG. 1K is an partially exploded perspective view of series connection of the battery devices with the connector according to the present invention. As shown in FIG. 1K, the connector 18 is disposed on a battery device 1A and a battery device 1B so as to electrically connect the cathode conductive bump 131 of the battery device 1B and the anode conductive bump 110 of the battery device 1A, and thus the battery device 1A and the battery device 1B are connected in series/parallel series. In another embodiment, the metal block 182 with eccentric screw 183 may be replaced by a horizontal tighting block or alike. The horizontal tighting block may horizontally press the anode conductive bump or the cathode conductive bump toward the base 180 to be tight.

FIG. 2 is a perspective view of a battery device according to another embodiment of the present invention. The battery device 2 includes: a reaction trough frame 20, an anode conductive element 21 (not shown), two sets of cathode conductive elements 22, a metallic fastener 23, and a buckling member 24.

Comparing battery device 2 with aforementioned battery device 1, the significant difference is that there are two holes 202 formed on the sides of the reaction trough frame 20, the anode conductive element 21 has two anode conductive bumps 210 protruding from the holes 202, and there are two cathode conductive bumps 231 formed on the metallic fastener 23. In addition, comparing with the aforementioned metallic fastener 13, the metallic fastener 23 has more opening portions 230 (not labeled). On the surface of the metallic fastener 23, such opening portions 230 form a plurality of crossed structures. Also, a recess or notch may be formed on the anode conductive element 210 and cathode conductive element 231 so that it is more convenient for a user to put wires on the anode conductive element 210 and the cathode conductive element 231. However, the function of such recesses is not limited to this.

Referring to FIG. 3, a flow chart illustrating the method for packaging the battery device is provided according to the present invention. The method includes the following steps.

In Step S31, dispose the anode conductive element inside the reaction trough frame, and make the anode conductive bump of the anode conductive element protrude from the reaction trough frame via the holes. The reaction trough frame is a solid body made of materials like plastic, artificial or natural rubber, EPDM, and so on. The reaction trough frame is highly elastic. Naturally, the reaction trough frame may also be designed to have characteristics like acid or alkaline resistance. Furthermore, the anode conductive element is made of Al, Zn, Mg and/or other solid, polymer electrolytic materials. The number of the anode conductive bumps and holes is also customizable depending on user requirements. Next, proceed to Step S32.

In Step S32, make the cathode conductive elements fully cover the first and second openings of the reaction trough frame so as to form the reaction region inside the reaction trough frame for accommodating electrolyte therein; then, fill electrolyte into the reaction region. The cathode conductive element is a laminated fiber structure comprising a metal net layer sandwiched between two carbon dust layers. The carbon dust layer is made of carbon fiber and/or graphite. The aperture size of these fiber holes only allows gas molecules to pass, so that the materials of the cathode conductive element have the characteristics of providing ventilation and being waterproof. Next, proceed to Step S33.

In Step S33, dispose the metallic fastener on the surfaces of the cathode conductive element and the reaction trough frame. A plurality of openings of the metallic fastener expose a portion of the surface of the cathode conductive element, as well as a portion of the surface of the reaction trough frame. In addition, the design for the metallic fastener can be an integrated design, or a separated, symmetrical design, etc. Next, proceed to Step S34.

In Step S34, buckle and fasten the metallic fastener with at least a buckling member so as to further fasten the battery device. The structure of the buckling member may be a common metallic clamp. The whole structure of the battery device 1 becomes stronger through the pressure provided by buckling member 14. Note that the number and shape of the buckling member can be customized depending on user requirements.

Step S32 further includes deposing a leak-proof member on the contact surface between the reaction trough frame and the cathode conductive element so as to prevent the electrolyte from leaking out of the reaction region. The leak-proof member may further distribute harmful stress, prevent leakage of electrolyte, and fasten the reaction trough frame 10 and the cathode conductive element 12 on their relative positions. The leak-proof member 15 may be made of elastic materials like artificial or natural rubber. In Step S32, an insulating element can be disposed on the surface of the cathode conductive element in order to prevent the cathode conductive element from short-circuiting with the anode conductive element because of the resultants generated during the battery reaction.

Referring to FIG. 4, a flow chart illustrating the steps of the method for disassembling and recycling the battery device is provided according to the present invention. The method of disassembling and recycling includes the following steps.

In Step S41, separate the metallic fastener, the cathode conductive element, the anode conductive element and the reaction trough frame from the battery device. In one embodiment of the invention, the battery device is placed into a track device to fulfill the separation of the metallic fastener, the cathode conductive element, the anode conductive element and the reaction trough frame from the battery device. The design of the track device may be a single track, multiple tracks, and so on, depending on the practical requirements. Next, proceed to Step S42.

In Step S42, clean the metallic fastener, the reaction trough frame, the cathode conductive element and/or the anode conductive element in order to remove resultants generated during the reaction of the battery device. Next, proceed to Step S43.

In Step S43, recycle the cleaned metallic fastener, the cathode conductive element, the anode conductive element and/or the reaction trough frame and proceed to a subsequent reutilizing process. In a preferred embodiment, the cleaning can be done by water flushing, dry cleaning or other physical or chemical cleaning methods, similar to that of the prior art. The reutilizing process performs the packaging operations of a new battery device by reutilizing the recycled metallic fastener, the cathode conductive element, the anode conductive element and/or the reaction trough frame.

In one embodiment, there may be at least a leak-proof member disposed on the contact surface between the reaction trough frame and the cathode conductive element in order to prevent leakage of the electrolyte. Therefore, Step S41 may further include an additional step of separating the leak-proof member that is disposed on the contact surface between the reaction trough frame and the cathode conductive element. In addition, the battery device may have at least one layer of an insulating element applied on the surface of the cathode conductive element, which is applicable to preventing the resultants from coming into contact with the anode conductive element during the battery reaction and thus preventing a short circuit. Therefore, in that case, Step S41 includes an additional step of separating the insulating element from the cathode conductive element.

To conclude, with regard to the battery device according to the present invention, first an anode conductive element is disposed inside a reaction trough frame. The anode conductive element has at least an anode conductive bump protruding from holes on the sides of the reaction trough frame. Then, there are two sets of cathode conductive elements covering the first opening and second opening of the reaction trough frame in a top and bottom manner, respectively. Also, there is a metallic fastener having at least a cathode conductive bump disposed on the surface of the two sets of the cathode conductive elements and on the surface of the reaction trough frame. The opening portion of the metallic fastener also exposes a portion of the surface of the two sets of the cathode conductive elements, as well as a portion of the surface of the reaction trough frame. The metallic fastener also electrically couples with the cathode conductive elements. Finally, there is at least a buckling member that serves to fasten the metallic fastener.

As a result, the cathode conductive bump and the anode conductive bump provide electricity to external devices. The said battery device and method of disassembling and recycling thereof provide a simple architecture and an easier way to package and disassemble, thereby overcoming the drawbacks due to the complicated battery architecture in the prior art. The invention further provides a user with a more convenient, rapid, and cost-effective way to package, disassemble and/or recycle the battery device, such that both time and cost can be saved.

It should be noted that the aforementioned embodiments are provided to explain the features and advantages of the present invention, and not intended to limit the scope thereof. Any equivalent change or modification made to the disclosure of the invention belongs to the scope of the invention as established by the following claims.

1. A battery device comprising:
a reaction trough frame having a first opening, a second opening, and at least one hole;
an anode conductive element, disposed inside the reaction trough frame, having at least an anode conductive bump, the anode conductive bump protruding from the reaction trough frame through the hole in the reaction trough frame;
at least two sets of cathode conductive elements fully covering the first opening and second opening of the reaction trough frame, respectively, thereby forming a reaction region for accommodating electrolyte therein; and
a metallic fastener disposed on surfaces of the cathode conductive elements and the reaction trough frame and electrically coupled to the cathode conductive elements,
wherein the metallic fastener has at least an opening portion, and the opening portion exposes a portion of the surface of the cathode conductive elements, as well as a portion of the surface of the reaction trough frame; and the metallic fastener has at least a cathode conductive bump so that the battery device provides electricity by the anode conductive bump and/or the cathode conductive bump.

2. The battery device of claim 1, further comprising:
a buckling member configured to buckle and fasten the metallic fastener, wherein the surface of the buckling member is applied with an insulating layer.

3. The battery device of claim 1, further comprising:
a leak-proof member disposed on the contact surface between the cathode conductive elements and the reaction trough frame, so as to prevent leakage of electrolyte.

4. The battery device of claim 1 further comprising: an insulating element disposed on the surface of the cathode conductive element in order to prevent the cathode conductive element from short-circuiting with the anode conductive element.

5. The battery device of claim 1, wherein the reaction trough frame has an inlet applicable to view in gaseous fuel needed for battery electrolysis, and an outlet applicable to exhausting gaseous wastes after completion of the battery electrolysis.

6. The battery device of claim 5, further comprising a top plate element applicable to assembling a plurality of the battery devices, thereby forming a battery module, wherein the top plate element comprises an anode opening corresponding to the anode conductive bump, an cathode opening corresponding to the cathode conductive bump, an inlet opening corresponding to the inlet, and an outlet opening corresponding to the outlet.

7. The battery device of claim 1, wherein the metallic fastener has a convex rib applicable to strengthening the metallic fastener.

8. The battery device of claim 1, wherein the cathode conductive element has a carbon dust layer and a metallic net layer which is made of nickel applicable to electrically coupling with the metallic fastener.

9. The battery device of claim 1, further comprising at least a connector disposed on a first battery device and a second battery device to thereby electrically connect the cathode conductive bump of the first battery device and the anode conductive bump of the second battery device, thereby allowing the first battery device and the second battery device to be connected in series.

10. The battery device of claim 9, wherein the connector comprising:
a base having at least a penetrating opening for holding the cathode conductive bump of the first battery device and the anode conductive bump of the second battery device and allowing the cathode conductive bump and the anode conductive bump to come into indirect contact with each other; and
a metal block having an eccentric screw therein and configured to be pushed under rotation of the eccentric screw until the cathode conductive bump and the anode conductive bump are fixed in position to the at least a penetrating opening.

11. A method of packaging the battery device of claim 1, comprising the steps of:
(1) disposing the anode conductive element inside the reaction trough frame and making the anode conductive bump protrude from the reaction trough frame through the hole in the reaction trough frame;
(2) covering the first opening and second opening of the reaction trough frame, respectively, by the cathode conductive element, thereby forming a reaction region, and filling electrolyte into the reaction region; and
(3) disposing the metallic fastener on surfaces of the cathode conductive element and the reaction trough frame.

12. The method of claim 11, further comprising:
Step (4) using a buckling member to buckle and fasten the metallic fastener.

13. The method of claim 11, wherein Step (2) further comprises: disposing at least a leak-proof member on the contact surface between the cathode conductive element and the reaction trough frame in order to prevent leakage of electrolyte.

14. The method of claim 11, wherein Step (2) further comprises: disposing an insulating element on the surface of the cathode conductive element in order to prevent the cathode conductive element from short-circuiting with the anode conductive element.

15. A method of disassembling and recycling the battery device of claim 1, comprising the steps of:
(1) separating the metallic fastener, the cathode conductive element, the anode conductive element and the reaction trough frame from the battery device;
(2) cleaning the metallic fastener, the reaction trough frame, the cathode conductive element and/or the anode conductive element in order to remove resultants generated during the reaction of the battery device; and
(3) recycling the cleaned metallic fastener, the cathode conductive element, the anode conductive element and/or the reaction trough frame and proceeding to a subsequent reutilizing process.

16. The method of claim 15, wherein in Step (1) the battery device is placed into a track device to fulfill the separation of the metallic fastener, the cathode conductive element, the anode conductive element and the reaction trough frame from the battery device.

17. The method of claim 15, wherein the reutilizing process performs the packaging operations of a new battery device by reutilizing the recycled metallic fastener, the cathode conductive element, the anode conductive element and/or the reaction trough frame.
